(19) United States
(12) Patent Application Publication
(10) Pub. No.: US 2026/0326330 A1
(43) Pub. Date: Oct. 22, 2026

(54) CUTTING MACHINE TO ALLOW THE CUTTING OF FLEXIBLE MATERIALS

(71) Applicant: ELEKTROTEKS ELEKTRONIK TEKSTIL SANAYI VE TICARET ANONIM SIRKETI, Bursa (TR)

(72) Inventors: SERKAN GULER, Bursa (TR); HUSEYIN HAMIT MELEK, Bursa (TR)

(73) Assignee: ELEKTROTEKS ELEKTRONIK TEKSTIL SANAYI VE TICARET LIMITED SIRKETI, Bursa (TR)

(21) Appl. No.: 18/853,421

(22) PCT Filed: Mar. 7, 2024
(86) PCT No.: PCT/TR2024/050221

§ 371 Date: Oct. 2, 2024

(30) Foreign Application Priority Data
Dec. 6, 2023 (TR) 2023/016635

(51) Int. Cl. B26D 7/02; B26D 1/08; B26D 3/00; B26D 7/06

(52) U.S. Cl. CPC B26D 7/02; B26D 1/08; B26D 3/006; B26D 7/0616

(57) ABSTRACT

The provided is a cutting machine to allow the cutting of flexible materials, including at least one transport element on which the machine is placed, at least one pressure element positioned on said transport element and configured to at least partially compress the flexible material, at least one cutter to allow the cutting of flexible material, and at least one guiding element to allow said cutter to perform precise cutting. The pressure element includes at least one pressure area to hold the flexible material by applying pressure and at least one working area that allows the movement of the guiding element to allow the precise cutting of the flexible material, and it includes at least one plate positioned to apply pressure to the flexible material in said pressure area, and said plate is configured to move at least partially on a first axis and on a third axis.

### CROSS-REFERENCE TO THE RELATED APPLICATIONS

This application is the national phase entry of International Application No. PCT/TR2024/050221, filed on Mar. 7, 2024, which is based upon and claims priority to Turkish Patent Application No. 2023/016635, filed on Dec. 6, 2023, the entire contents of which are incorporated herein by reference.

### TECHNICAL FIELD

The invention relates to a cutting machine to allow the cutting of flexible materials, comprising at least one transport element on which the machine is placed, at least one pressure element positioned on said transport element and configured to at least partially compress the flexible material, at least one cutter to allow the cutting of flexible material, and at least one guiding element to allow said cutter to perform precise cutting.

### BACKGROUND

Sponge cutting machine generally describes a machine used to cut sponge material into a specific shape. These machines are often used in industrial or manufacturing environments and allow sponge to be cut into specific sizes or shapes. Sponge is a material that is often used in many different application areas, such as mattress, furniture, automotive interiors and the packaging industry. Sponge cutting machines enable the sponge to be cut in the desired forms and sizes, speeding up production processes and allowing more precise results to be obtained.

Such machines usually have automatic or semi-automatic control systems and allow operators to cut sponge material to a specific pattern or size. The sponge cutting machines are used to increase efficiency and optimize material usage in the production processes.

Application No. EP1888306, known in the literature, is a holding device used in machines in which the blocks made of soft materials are processed, especially designed for the foam contour cutting machines. The device comprises holding plates that can be adjusted vertically and moved in parallel. The cutting machine has a structure in which the cutting tool is placed on at least one central support and these central supports are held on a machine chassis that can be adjusted in width to enable rapid and automatic changing of blocks. It provides an embodiment in which the holding device comprises support members that can be adjusted vertically to the shelves. These support elements support a holding frame and the holding plates are longitudinally slidably guided within this frame. The holding plates are separated from each other by a gap exceeding the width of the central support, at least in the central support region.

Sponge cutting machines may encounter various problems during their use. These problems can occur depending on various factors such as machine use, maintenance, material quality or processing parameters. Here are some of the potential problems encountered with the sponge cutting machines:
Blade Wear or Damage: The blades used in the sponge cutting machines may become worn or damaged over time. This may reduce the cutting quality and affect the performance of the machine.
Cutting Speed Problems: Problems with machine settings or control systems may prevent the cutting of the sponge at the desired speed. This may slow down the production processes.
Automation Problems: Problems with control systems or sensors may occur in the automatic sponge cutting machines. In this case, the correct operation of the machine may be prevented.
Blade Adjustment Problems: Failure to adjust the blades correctly may affect the cutting quality. Proper positioning of the blades is important.
Material Quality: Poor quality or non-uniformity of the sponge material used may cause irregular cuts.

As a result, all the above-mentioned problems have made it necessary to realize a novelty in the relevant technical field.

### SUMMARY

The present invention relates to a cutting machine to eliminate the above-mentioned disadvantages and bring the new advantages to the relevant technical field.

An object of the invention is to provide a cutting machine with increased cutting precision, easy manufacturing and reduced maintenance costs.

In order to accomplish all the objects mentioned above and to be revealed from the detailed description below, the present invention is a cutting machine to allow the cutting of flexible materials, comprising at least one transport element on which the machine is placed, at least one pressure element positioned on said transport element and configured to at least partially compress the flexible material, at least one cutter to allow the cutting of flexible material, and at least one guiding element to allow said cutter to perform precise cutting. Accordingly, the novelty is that the pressure element comprises at least one pressure area to hold the flexible material by applying pressure and at least one working area that allows the movement of the guiding element to allow the precise cutting of the flexible material, and it comprises at least one plate positioned to apply pressure to the flexible material in said pressure area, and said plate is configured to move at least partially on a first axis parallel to the ground and on a third axis positioned perpendicular to the first axis. Thus, a cutting machine with increased cutting precision, easy manufacturing and reduced maintenance costs is obtained.

A possible embodiment of the invention is characterized in that there is a large number of plates and each plate is configured to be moved relative to each other. Thus, the plates, which can be spaced based on the width of the flexible material, ensure that the flexible material is held and compressed stably during cutting.

Another possible embodiment of the invention is characterized in that the plates comprise at least one first drive element to which they are connected so that they can be moved relative to each other, and said first drive element comprises a pulley of different diameters connected to each plate to allow movement transmission. Thus, this pulley system, which can be adjusted based on the width of the flexible material, controls the relative movement between the plates and ensures precise processing of the flexible material during cutting.

Another possible embodiment of the invention is characterized in that each plate comprises at least one spline bearing and said spline bearings are positioned side by side on at least one spline shaft. Thus, the plates can be slid along the third axis through the channels on the spline shaft, providing freedom of movement of the plates.

Another possible embodiment of the invention is characterized in that said spline shaft comprises at least one second drive element to which it is connected to move the plate on the first axis by rotating around itself. Thus, the rotational movement of the spline shaft enables the plates to be converted into a linear movement on the first axis and makes it possible to cut the flexible material in the desired direction during cutting.

Another possible embodiment of the invention is characterized in that the transport element comprises at least one transport slide positioned on the first axis and at least one transport conveyor located on said transport slide. Thus, the flexible material can be moved linearly on the first axis via the transport conveyor, which allows it to be brought to the desired position during cutting.

Another possible embodiment of the invention is characterized in that the guiding element is configured to be at least partially displaced on the second axis. Thus, the guiding element can precisely move the cutting element over the flexible material during cutting.

Another possible embodiment of the invention is characterized in that it comprises at least one chassis for positioning the cutter thereon. Thus, the cutter can be moved in a certain axis through the struts on the chassis, and the cutting process can be carried out under control.

Another possible embodiment of the invention is characterized in that said chassis comprises at least one beam and at least one strut on opposite sides of said beam. Thus, the chassis has a structure that can move the cutter in the desired direction during cutting.

Another possible embodiment of the invention is characterized in that the flexible material is a mattress. The cutting machine is thus particularly optimized for the precise cutting of flexible materials, such as sponge.

### BRIEF DESCRIPTION OF THE DRAWINGS

FIG. 1 shows a representative perspective view of the cutting machine of the invention.

FIG. 2 shows a representative perspective view of the pressure element in the cutting machine of the invention.

### DETAILED DESCRIPTION OF THE EMBODIMENTS

In this detailed description, the subject of the invention is only described with the examples without any limiting effect for a better understanding of the subject.

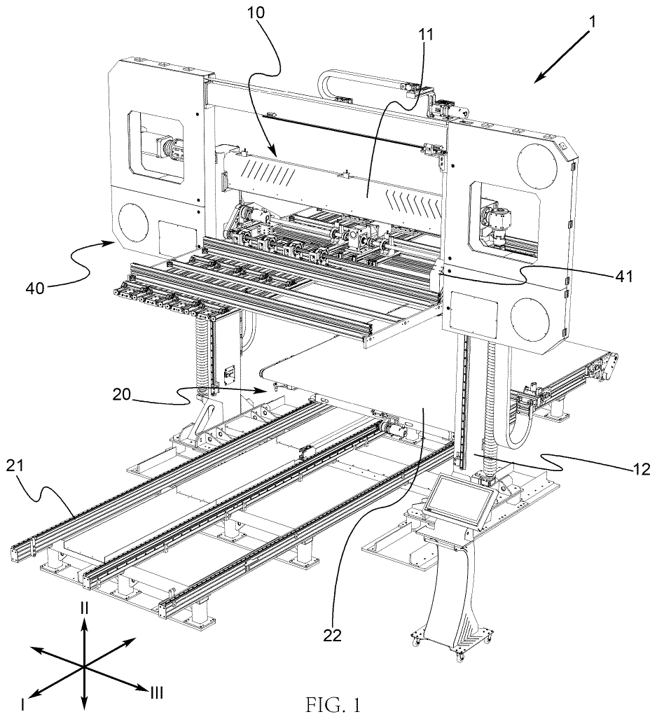

FIG. 1 shows a representative perspective view of the cutting machine (1) of the invention. Accordingly, the cutting machine (1) of the invention is a device generally used in the industrial production processes and is designed to cut or saw a certain material in a certain way. Particularly, the cutting machine (1) is configured to process the flexible materials. The flexible material in the invention is a mattress sponge in the preferred embodiment of the invention. The cutting machine (1) performs the cutting function of the sponge in mattress manufacturing. The cutting machine (1) basically comprises at least one chassis (10), at least one transport element (20) and at least one pressure element (30).

Said transport element (20) allows the flexible material to be carried on the ground. To do this, the transport element (20) comprises at least one transport slide (21) and at least one transport conveyor (22). The transport element (20) is configured to allow the flexible material to be moved linearly on a first axis (I) (it is assumed to be parallel to the ground) and at the same time to rotate the flexible material around itself. For this purpose, the transport slide (21) extends in the direction of the first axis (I). The transport conveyor (22) is also configured to be at least partially displaced along the transport slide (21). In addition, the transport conveyor (22) can be rotated at least partially around itself. In this way, it is possible to rotate the flexible material around itself and cut it in different axes. The transport conveyor (22) is also used as a conveyor for positioning the flexible material placed thereon.

Said chassis (10) allows the pressure element (30) and at least one cutter (40) to be positioned thereon. For this purpose, the chassis (10) comprise at least one beam (11) and at least one strut (12) on opposite sides of said beam (11). The cutter (40) on the chassis (10) can be moved relative to the struts (12) in the direction of a second axis (II) (it is assumed to extend perpendicular to the ground). The cutter (40) may include cutting elements and equipment that allow cutting the flexible material. There is at least one guiding element (41) on the chassis (10), particularly on the beam (11). Said guiding element (41) allows the cutting element on the cutter (40) to be moved precisely on the flexible material in a predetermined route. The guiding element (41) can be moved on the cutter (40) in the direction of a third axis (III) (it is assumed to be parallel to the ground and perpendicular to the first axis (I)). With the freedom of movement of this embodiment, it is ensured that the guiding element (41) can actually be positioned in the desired position on the coordinate system.

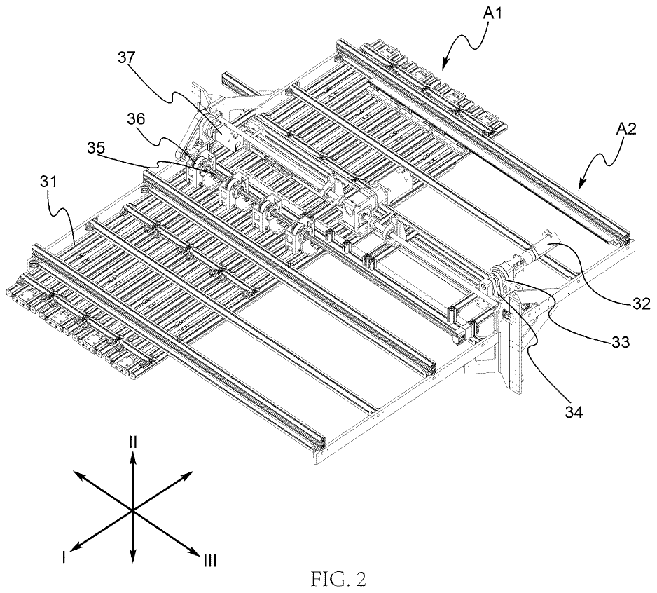

FIG. 2 shows a representative perspective view of the pressure element (30) in the cutting machine (1) of the invention. Accordingly, the pressure element (30) ensures that the flexible material placed on the transport element (20) is at least partially compressed in order to prevent it from moving during cutting. For this purpose, the pressure element (30) is configured to be at least partially displaced on the second axis (II). In addition, the pressure element (30) is moved in the first axis (I) to allow the cutting function of the flexible material to be improved.

The pressure element (30) comprises at least one plate (31) to be leaned against the flexible material. There are many plates (31) side by side on the pressure element (30). In a possible embodiment of the invention, there are 4 plates (31). The plates (31) are moved relative to each other and can be spaced based on the width of the flexible material. In other words, the first of the plates (31) is fixed on the third axis (III). The second can move on the third axis (III) at X unit speed relative to the first, the third can move at 2× unit speed relative to the first, and the fourth can move at 3× unit speed relative to the first. To do this, the plates (31) are connected to at least one first drive element (32). There are essentially multiple pulleys (33) of different diameters on said first drive element (32). Each of these pulleys (33) is connected to a plate (31), allowing them to be moved together from a single engine. Thanks to the different diameters of the pulleys (33), the displacement on the belts (34) is different and the plates (31) can be moved relative to each other. This allows the relative movement of the plates (31) to apply equal pressure on the flexible material and to improve the cutting precision.

In order for the plates (31) on the pressure element (30) to move linearly relative to each other, they are lined up side by side in direction of the third axis (III) on a spline shaft (35). There are multiple channels side by side around the cylinder on the spline shaft (35). There is at least one spline bearing (36) on each of the plates (31) as a counterpart. Said spline bearing (36) is at least partially slidable along the third axis (III) on the spline shaft (35). In this way, the freedom of movement of the plates (31) is provided. In addition, the spline shaft (35) also allows the pressure element (30) to be moved on the second axis (II). For this purpose, the spline shaft (35) is connected to at least one second drive element (37). There may be a belt-pulley (34) mechanism between said second drive element (37) and the spline shaft (35). In this way, the safe force transfer can be made between two elements. By rotating the spline shaft (35) around itself, the spline bearing (36) converts the rotational movement into the linear motion on the first axis (I).

The pressure element (30) comprises two areas in terms of structure. The pressure element (30) has a pressure area (A1) and a working area (A2). The sizes of said pressure area (A1) and working area (A2) may vary depending on the size of the flexible material being processed. The pressure area (A1) is the part in which the plates (31) are located and the flexible material is compressed. The working area (A2) is the section that provides space for the movement of the guiding element (41) during cutting. The guiding element (41) continuously moves in the working area (A2) and allows the flexible material to be cut.

In a possible use of the invention, the flexible material is placed on the transport element (20) and the pressure element (30) is aligned on the flexible material. Subsequently, the pressure element (30) applies pressure to the flexible material by spacing the plates (31) according to the width of the flexible material. For this purpose, the plates (31) are spaced by the first drive element (32). During cutting, the guiding element (41) is placed in the working area (A2) and allows the cutting element to be guided precisely during cutting. During this process, the second drive element (37) on the transport slide (21) and the pressure element (30) is actively used to move the flexible material on the first axis (I).

The benefits obtained with all these embodiments are as follows:
Flexible Material Processing Ability: This cutting machine (1) is specially designed for cutting flexible sponge material. Flexible materials often require precision cutting, so the machine is capable of cutting materials such as sponge with precision. The multi-axis mobility in the transport element (20) and the pressure element (30) allows the flexible material to be cut in different axes. This makes cutting of complex shapes and patterns possible.
Compression with Pressure Element (30): The pressure element (30) compresses the sponge material and provides a smooth cut. This prevents the material from slipping while cutting and increases cutting precision. The guiding element (41) ensures that the cutting element directs the flexible material correctly during cutting, which increases cutting precision.
Drive System of Plate (31): The drive system of plate (31) used to ensure the spacing between the plates (31) controls the relative movement of the plates (31) relative to each other. This improves quality and precision of cutting. The spline shaft (35) system enables the pressure element (30) to be adjusted based on the width of the flexible material and enables the flexible material to be held stably during cutting.
Working area (A2) and Pressure area (A1); The pressure element (30) has two different areas: This makes it possible to focus on a specific area of the material being processed and ensure stability during cutting. Adjustable features in the pressure area (A1) and working area (A2) enable the processing of sponge materials of different sizes, offering a wide range of applications.

The scope of protection of the invention is described in the attached claims and cannot be limited to what is explained in this detailed description for the exemplary purposes. It is clear that a person skilled in the art can produce similar embodiments in the light of what is explained above, without deviating from the main theme of the invention.

### REFERENCE NUMBERS GIVEN IN THE DRAWINGS

1 Cutting Machine
10 Chassis
11 Beam
12 Strut
20 Transport Element
21 Transport Slide
22 Transport Conveyor
30 Pressure Element
31 Plate
32 First Drive Element
33 Pulley
34 Belt
35 Spline Shaft
36 Spline Bearing
37 Second Drive Element
40 Cutter
41 Guiding Element
I First Axis
II Second Axis
III Third Axis
A1 Pressure Area
A2 Working Area

What is claimed is:

1. A cutting machine to allow cutting of flexible materials, comprising
at least one transport element where the cutting machine is placed,
at least one pressure element positioned on the transport element and configured to at least partially compress the flexible material,
at least one cutter to allow the cutting of flexible material, and
at least one guiding element to allow the cutter to perform precise cutting, wherein
the pressure element comprises at least one pressure area to hold the flexible material by applying pressure and at least one working area that allows movement of the guiding element to allow precise cutting of the flexible material, and
the pressure element comprises at least one plate positioned to apply pressure to the flexible material in the pressure area, and
the plate is configured to move at least partially on a first axis parallel to ground and on a third axis positioned perpendicular to the first axis.

2. The cutting machine according to claim 1, wherein there is a plurality of plates and each of the plurality of plates is configured to be moved relative to each other.

3. The cutting machine according to claim 2, wherein the plurality of plates comprise at least one first drive element, wherein the plurality of plates are connected to the first drive element, wherein the plurality of plates is allowed to be moved relative to each other, and the first drive element comprises a pulley of different diameters connected to each of the plurality of plates to allow movement transmission.

4. The cutting machine according to claim 1, wherein each plate comprises at least one spline bearing and the spline bearings are positioned side by side on at least one spline shaft.

5. The cutting machine according to claim 4, wherein the spline shaft comprises at least one second drive element, wherein the spline shaft is connected to the second drive element to move the plate on the first axis by rotating around the spline shaft.

6. The cutting machine according to claim 1, wherein the transport element comprises at least one transport slide positioned on the first axis and at least one transport conveyor located on the transport slide.

7. The cutting machine according to claim 1, wherein the guiding element is configured to be at least partially displaced on a second axis.

8. The cutting machine according to claim 1, wherein the cutting machine comprises at least one chassis for positioning the cutter thereon.

9. The cutting machine according to claim 8, wherein the chassis comprises at least one beam and at least one strut on opposite sides of the beam.

10. The cutting machine according to claim 1, wherein the flexible material is a mattress.
